(19) United States
(12) Patent Application Publication
(10) Pub. No.: US 2023/0386198 A1
(43) Pub. Date: Nov. 30, 2023

(54) DISASTER RESPONSE SYSTEM USING SATELLITE IMAGE

(71) Applicant: CONTEC CO., LTD., Daejeon (KR)

(72) Inventor: Sunghee LEE, Sejong-si (KR)

(73) Assignee: CONTEC CO., LTD., Daejeon (KR)

(21) Appl. No.: 17/929,445

(22) Filed: Sep. 2, 2022

(30) Foreign Application Priority Data
May 26, 2022 (KR) 10-2022-0064593

(51) Int. Cl. G06V 20/13; G06V 20/52; G06Q 50/26

(52) U.S. Cl. CPC G06V 20/13; G06V 20/52; G06Q 50/26

(57) ABSTRACT

Provided is a disaster response system using a satellite image, the disaster response system including a receiver configured to receive a captured image from a satellite; a storage configured to operatively couple to the receiver and to store the received satellite image; and a central processing device configured to operatively couple to the receiver and the storage and to predict a damage occurrence probability according to occurrence of a disaster through a time series change in the satellite image, to determine a damage occurrence status, and to calculate a scale of damage in response to occurrence of the damage.

### CROSS-REFERENCE TO RELATED APPLICATIONS

This application claims the benefit under 35 USC § 119(a) of Korean Patent Application No. 10-2022-0064593 filed on May 26, 2022 in the Korean Intellectual Property Office, the entire disclosure of which is incorporated herein by reference for all purposes.

### BACKGROUND

### 1. Field

At least one example embodiment relates to a disaster response method and system for performing the same, and more particularly, to a disaster response system using a satellite image.

### 2. Description of Related Art

Disasters may include natural disasters, such as extreme weather events and disasters, such as occurrence of accidents, for example, wildfires and the like. Such disasters are surprise and local and may become a bigger issue unless a response corresponding thereto is promptly performed.

To solve such issues, a disaster response system using a satellite image may be considered. However, although a damaged area may be simply specified by using a satellite image, it is not easy to accurately verify a spread degree of damage.

In detail, the disaster response system may have a degraded accuracy when determining an exact scale of damage and may perform prediction corresponding to a level of guess based on past occurrence experience. For example, if it is difficult to predict occurrence of tsunami in the vicinity of the coast, significant damage to property and human life will occur. Therefore, it is important to accurately calculate a scale of damage in a situation in which an input size of manpower for recovery needs to be predicted.
Patent documents include Chinese Patent No. 212675675 (2021.03.09) and Korean Patent Registration No. 10-1944616 (2019.01.25).

### SUMMARY

An objective of at least one example embodiment is to provide a disaster response system using a satellite image.

An objective of at least one example embodiment is to provide a system capable of coping with monitoring, warning, and damage scale estimation related to disasters through a single process using a satellite image.

According to an aspect of at least one example embodiment, there is provided a disaster response system using a satellite image, the disaster response system including a receiver configured to receive a captured image from a satellite; a storage configured to operatively couple to the receiver and to store the received satellite image; and a central processing device configured to operatively couple to the receiver and the storage and to predict a damage occurrence probability according to occurrence of a disaster through a time series change in the satellite image, to determine a damage occurrence status, and to calculate a scale of damage in response to occurrence of the damage.

The central processing device may include a monitoring unit configured to predict a type of disaster and the damage occurrence probability in a satellite image shooting area through connection to a geographic information system (GIS) server configured to provide spatial geographic information and a weather information providing server configured to provide weather information; a determination unit configured to detect a time series change rate of the received satellite image and to determine occurrence of damage according to the disaster; and a damage calculator configured to calculate the scale of damage according to the occurrence of the disaster.

The monitoring unit may include a zone detection module configured to specify the satellite image shooting area based on the weather information; a first prediction module configured to predict a type of damage predicted for each zone of the specified satellite image shooting area; and a second prediction module configured to predict the damage occurrence probability and a scale of damage based on the weather information and the type of damage predicted for each zone.

The determination unit may include a damage occurrence determination module configured to determine the damage occurrence status and a type of damage that has occurred through the satellite image; and a control module configured to specify a damaged area and to request a high-resolution satellite image of the damaged area.

The damage calculator may include a damage scale calculation module configured to distinguishably predict human damage using a damaged area and nearby terminal location information and physical damage using spatial geographic information; and a support scale estimation module configured to estimate a scale of support for recovery of damage according to the scale of damage. The damage calculator may be configured to detect a change in the satellite image of the damaged area through a deep learning module or an artificial intelligence (AI) server and to predict a degree of damage caused by the change in the satellite image, and to calculate first information on manpower and cost required for recovery of damage in the damaged area based on the predicted degree of damage.

The damage calculator may include a database configured to periodically receive, update, and manage information on a location and a scale of support manpower and equipment; and a support resource selection module configured to select support manpower and equipment using a real-time satellite image according to the scale of support estimated by the support scale estimation module, and the damage calculator may be configured to calculate second information on the support manpower and equipment required for recovery of the damage using the real-time satellite image, spatial geographic information, a cadastral map, auxiliary information on the weather information, and the first information on the manpower and the cost.

The damage calculator may be configured to detect the change in the satellite image of the damaged area and a change in the weather information through the deep learning module or the AI server and predict a degree of damage according to the change in the satellite image and the change in the weather information, and to calculate the first information on the manpower and the cost required for recovery of the damage in the damaged area and the second information on the support manpower and equipment required for recovery of the damage based on the predicted degree of damage.

The damage calculator may be configured to detect a change in traffic information from a first place to which the support manpower and equipment are to be dispatched to a second place in the damaged area through the deep learning module or the AI server, to predict a spread degree of damage according to an arrival time of the support manpower and equipment based on the change in the satellite image, a change in the weather information, and the change in the traffic information, to calculate an additional input of the support manpower and equipment based on the predicted spread degree of damage, and to control a portion of the additional input of the support manpower and equipment to be dispatched to a third place when the predicted spread degree of damage is predicted to be spread to the third place adjacent to the second place.

According to some example embodiments, it is possible to provide a system capable of coping with monitoring, warning, and damage scale estimation related to disasters through a single process using a satellite image.

According to some example embodiments, it is possible to predict a damage occurrence probability, to determine a damage occurrence status, and to predict a scale of damage according thereto based on a satellite image, spatial geographic information, and weather information.

According to some example embodiments, it is possible to predict a simple damage occurrence status and to accurately predict a type of damage and a scale of damage predicted for each specified zone.

According to some example embodiments, it is possible to more accurately predict not only a current degree of damage but also a scale of damage and a spread degree of damage in the future through deep learning artificial intelligence (AI) and to add and distribute manpower and equipment required for recovery in consideration of the spread degree of damage/damaged area.

The additional scope of applicability of the present invention may become apparent from the following detailed description. However, it will be clearly understood by one of ordinary skill in the art that various modifications and alterations may be made without departing from the spirit and scope of the present invention. Therefore, it should be understood that the detailed description and specific example embodiments, such as example embodiments of the present invention, are given by way of examples only.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a disaster response system using a satellite image according to an example embodiment;

FIG. 2 is a diagram illustrating a detailed configuration of a central processing device of a disaster response system according to an example embodiment;

FIG. 3 is a diagram illustrating a detailed configuration of a monitoring unit, a determination unit, and a damage calculator of a disaster response system according to an example embodiment;

FIG. 4 is a diagram illustrating a detailed configuration of a deep learning module or an artificial intelligence (AI) server that interacts with a disaster response system according to an example embodiment; and

FIG. 5 is a diagram illustrating a detailed configuration for information exchange between an AI server interacting a disaster response system and a damage calculator and an external server according to an example embodiment.

### DETAILED DESCRIPTION

Specific structural or functional descriptions related to example embodiments according to the concept of the present invention set forth herein are simply provided to explain the example embodiments according to the concept of the present invention and the example embodiments according to the concept of the present invention may be implemented in various forms and are not limited to the example embodiments described herein.

Various modifications may be made to the example embodiments according to the concept of the present invention. Therefore, the example embodiments are illustrated in the drawings and are described in detail with reference to the detailed description. However, the example embodiments are not construed as being limited to the specific disclosure and should be understood to include all changes, equivalents, and replacements within the idea and the technical scope of the present invention.

Although terms of “first,” “second,” and the like may be used to explain various components, the components are not limited to such terms. These terms are used only to distinguish one component from another component. For example, a first component may be referred to as a second component, or similarly, the second component may be referred to as the first component within the scope of the present invention.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

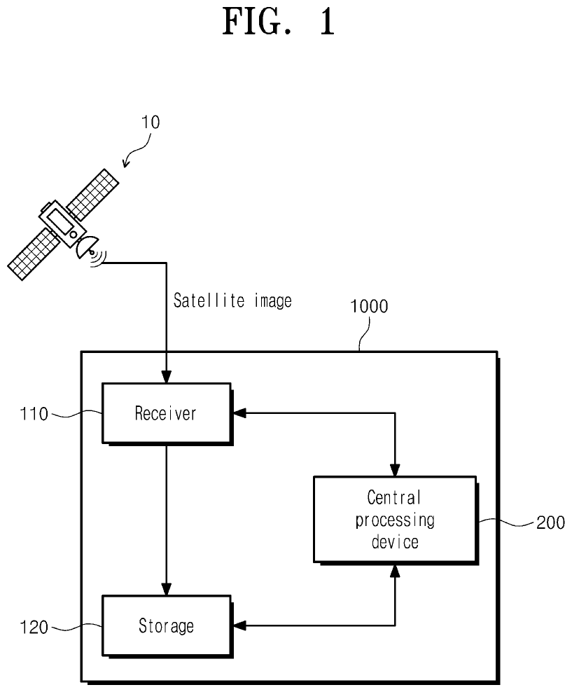

Hereinafter, example embodiments will be described in detail with reference to the accompanying drawings. However, the scope of the claims is not limited to or restricted by such example embodiments. Like reference numerals refer to like components throughout. A disaster response system using a satellite image according to an example embodiment is described with reference to the accompanying drawings. FIG. 1 is a diagram illustrating a configuration of a disaster response system using a satellite image according to an example embodiment. Referring to FIG. 1, a disaster response system 1000 may be configured as a plurality of modules/units that is implemented as a single apparatus or may be configured as a plurality of apparatuses in which a portion of modules/units is implemented as a separate apparatus. Here, the disaster response system 1000 may be implemented as an apparatus configured to receive a satellite image to cope with a disaster and to determine a degree of damage in a damaged area according to a change in the satellite image.

Referring to FIG. 1, the disaster response system 1000 may include a receiver 110, a storage 120, and a central processing device 200. The receiver 110 may be configured to receive a captured image from a satellite 10. The storage 120 may operatively couple to the receiver 110. The storage 120 may be configured to store the satellite image received from the receiver 110. The central processing device 200 may operatively couple to the receiver 110 and the storage 120. The central processing device 200 may be configured to predict a damage occurrence probability according to occurrence of a disaster through a time series change in the satellite image. The central processing device 200 may be configured to determine a damage occurrence status and to calculate a scale of damage in response to occurrence of the damage.

Therefore, the present invention may entitle a configuration and a specific operation of the disaster response system 1000 that predicts and detects a change in an object through a satellite image and infers a scale of damage. In this regard, it is possible to provide the disaster response system 1000 that all performs monitoring, detection, and scale calculation of damage occurring on the ground regardless of a type of disaster.

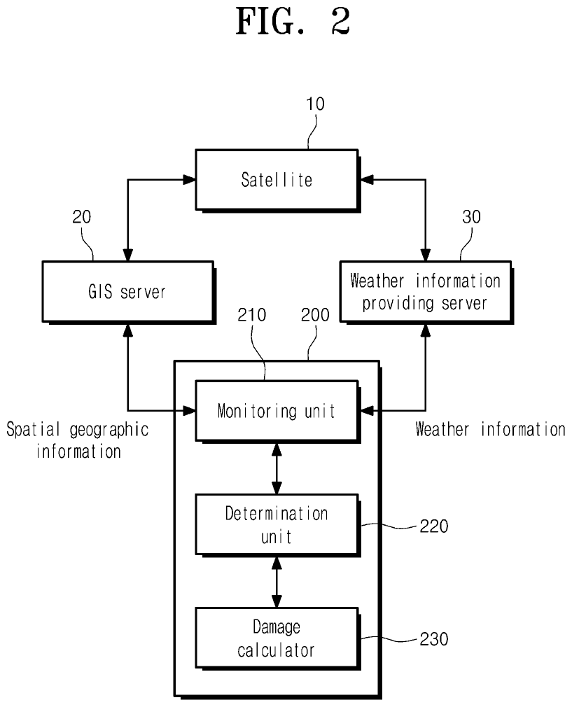

Each of the components of the disaster response system 1000 using the satellite image according to an example embodiment may predict/monitor a damage occurrence probability, may determine a damage occurrence, and may calculate a scale of damage through detailed components. Here, FIG. 2 is a diagram illustrating a detailed configuration of a central processing device of a disaster response system according to an example embodiment.

Referring to FIG. 2, the central processing device 200 may include a monitoring unit 210, a determination unit 220, and a damage calculator 230. The central processing device 200 may be configured to interact with a plurality of servers. The central processing device 200 may be configured to receive spatial geographic information through the receiver 110 of FIG. 1 through interaction with a geographic information system (GIS) server 20. The central processing device 200 may be configured to receive weather information through the receiver 110 of FIG. 1 through interaction with a weather information providing server 30.

Referring to FIGS. 1 and 2, the monitoring unit 210 may operatively couple to the receiver 110. The monitoring unit 210 may connect to the GIS server 20 configured to provide spatial geographic information and the weather information providing server 30 configured to provide weather information. The monitoring unit 210 may be configured to predict a type of disaster and a damage occurrence probability in a satellite image shooting area. The determination unit 220 may operatively couple to the receiver 110 and the monitoring unit 210. The determination unit 220 may be configured to detect a time series change rate of the received satellite image. The determination unit 220 may be configured to determine occurrence of damage according to the disaster based on the received time series change rate of the received satellite image.

The damage calculator 230 may operatively couple to the monitoring unit 210 and the determination unit 220. The damage calculator 230 may be configured to calculate the scale of damage according to the occurrence of the disaster. Referring to FIG. 2, the present invention may entitle a detailed configuration of the central processing device 200 that predicts a damage occurrence probability through a satellite image, spatial geographic information, and weather information, determines occurrence of damage, and infers a scale of damage according thereto.

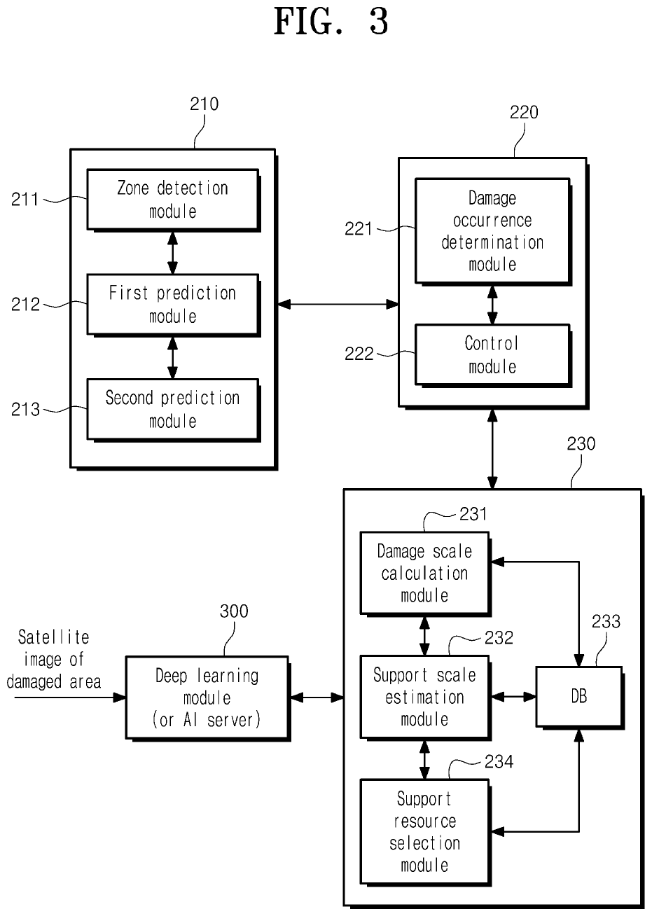

Meanwhile, each of the monitoring unit 210, the determination unit 220, and the damage calculator 230 of the central processing device 200 of the disaster response system 1000 using the satellite image according to an example embodiment may effectively calculate a damaged area, a type of damage, a damage occurrence status, a degree of damage, and a damage recovery method through more detailed configuration/modules. Here, FIG. 3 illustrates a detailed configuration of a monitoring unit, a determination unit, and a damage calculator of a disaster response system according to an example embodiment.

Referring to FIG. 3, the monitoring unit 210 may be configured to include a zone detection module 211, a first prediction module 212, and a second prediction module 213. The zone detection module 211 may be configured to specify a satellite image shooting area that is an area in which a satellite image is captured, based on weather information. The first prediction module 212 may operatively couple to the zone detection module 211. The first prediction module 212 may be configured to predict a type of damage predicted for each zone of the specified satellite image shooting area. The second prediction module 213 may operatively couple to the zone detection module 211 and the first prediction module 212. The second prediction module 213 may be configured to predict a damage occurrence probability and a scale of damage based on the weather information and the type of damage predicted for each zone. Therefore, the present invention may entitle the detailed configuration of the monitoring unit 210 that predicts a damage occurrence status and predicts a type of damage and a scale of damage predicted for each specified zone.

Referring to FIG. 3, the determination unit 220 may operatively couple to the monitoring unit 210. The determination unit 220 may be configured to include a damage occurrence determination module 221 and a control module 222.

The damage occurrence determination module 221 may be configured to determine the damage occurrence status and a type of damage that has occurred through the satellite image. The control module 222 may operatively couple to the damage occurrence determination module 221. The control module 222 may be configured to specify a damaged area and to request a high-resolution satellite image for the damaged area. Therefore, the control module 222 may more specifically define the damaged area and may more accurately verify a type of damage and a scale of damage through the received high-resolution satellite image. Therefore, the present invention may determine whether the damage has actually occurred due to a disaster and a type of the damage through the satellite image. Also, the present invention may entitle a detailed configuration of the determination unit that requests the high-resolution satellite image to infer more-detailed information.

Referring to FIG. 3, the damage calculator 230 may operatively couple to the monitoring unit 210 and the determination unit 220. The damage calculator 230 may be configured to include a damage scale calculation module 231 and a support scale estimation module 232. The damage calculator 230 may be configured to further include a database (DB) 233 and a support resource selection module 234.

The damage scale calculation module 231 may distinguishably predict human damage using a damaged area and nearby terminal location information and physical damage using spatial geographic information. The support scale estimation module 232 may operatively couple to the damage scale calculation module 231. The support scale estimation module 232 may be configured to estimate the scale of support for recovery of damage according to the scale of damage. Therefore, the present invention may calculate a scale of material damage using a change in an object and GIS information through the satellite image. Also, the present invention may entitle the contents that human damage is predicted based on location information of a terminal connected to a nearby base station.

The database 233 may operatively couple to the damage scale calculation module 231 and the support scale estimation module 232. The database 233 may be configured to periodically receive, update, and manage information on a location and a scale of support manpower and equipment. The support resource selection module 234 may operatively couple to the support scale estimation module 232 and the database 233. The support resource selection module 234 may be configured to select the support manpower and equipment using a real-time satellite image according to the scale of support estimated by the support scale estimation module 232. Here, the real-time satellite image may be a high-resolution real-time satellite image that is requested for the damaged area specified by the control module 222. Therefore, the present invention may entitle the contents that the damage calculator 230 determines an input of manpower and equipment to implement prompt recovery.

Referring to FIG. 3, the damage calculator 230 of the disaster response system 1000 according to an example embodiment may predict a degree of damage in consideration of a change (a change rate, a degree of damage, and a spread degree of damage) in the satellite image based on AI through a deep learning module or an AI server 300. Therefore, the damage calculator 230 may calculate manpower and cost information for recovery of damage in the damaged area and may calculate the information on the manpower and the equipment required for recovery of the damaged area in consideration of an amount of time used until the manpower and the equipment arrive. The detailed configuration of predicting a degree of damage in consideration of a change (a change rate, a degree of damage, and a spread degree of damage) in the satellite image based on AI is further described with reference to the accompanying drawings.

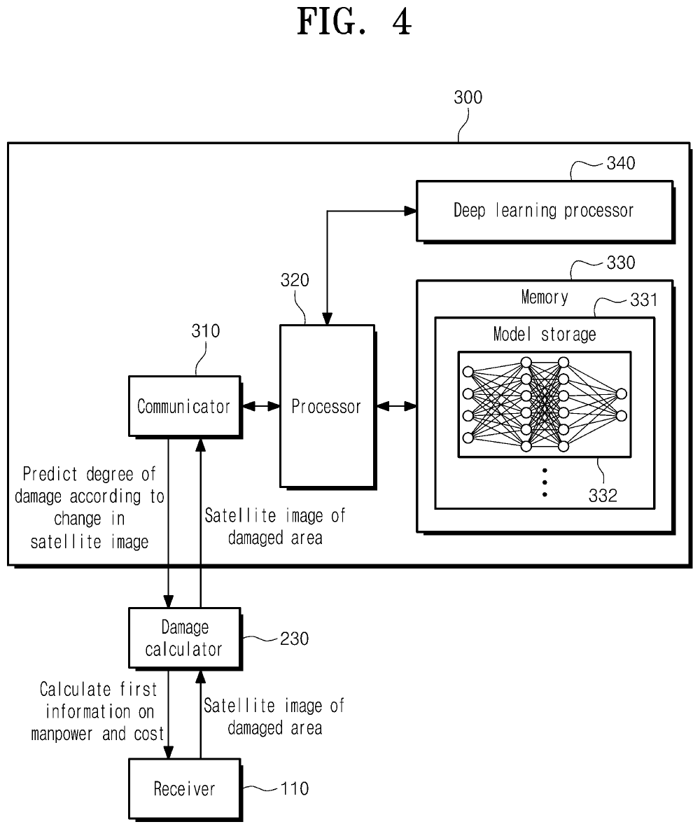

FIG. 4 is a diagram illustrating a detailed configuration of a deep learning module or an AI server that interacts with a disaster response system according to an example embodiment. Referring to FIG. 4, the AI server 300 may refer to a device that trains an artificial neural network with a machine learning algorithm or uses the trained artificial neural network. Here, the AI server 300 may include a plurality of servers and may perform distributed processing and may be configured as a 5G network, but is not limited thereto. Here, the AI server 300 may be included as a partial configuration of the central processing device 200 of the disaster response system 1000 and may perform at least a portion of AI processing.

The AI server 300 may include a communicator 310, a processor 320, a memory 330, and a running processor 340. The communicator 310 may transmit and receive data to and from the disaster response system 1000 or an external device, such as another AI apparatus.

The processor 320 may infer a result value for new input data using a learning model and may generate a response or a control instruction based on the inferred result value. The learning model may be a model that is being trained or trained stored in a model storage 331, which is described in the following.

The memory 330 may include the model storage 331. The model storage 331 may store the model (or, an artificial neural network 332) being trained or trained through the running processor 240. An example of the running processor 340 may be a deep learning processor, but is not limited thereto. Machine learning refers to detailed approach method that implements AI and deep learning refers to technology that uses an artificial neural network in a machine learning method.

The running processor 340 may train the artificial neural network 332 using training data. The learning model may be used while being mounted to the AI server 300, or may be used while being mounted to an external device.

The learning model may be implemented using hardware, software, or combination of hardware and software. When a portion of or all of the learning model is implemented as software, at least one instruction that constitutes the learning model may be stored in the memory 330.

The processor 320 may receive satellite images of a damaged area, may detect a change in the satellite images of the damaged area, and may predict a degree of damage according to the change in the satellite images through the damage calculator 230. The damage calculator 230 may calculate first information on the manpower and cost required for recovery of damage in the damaged area based on the predicted degree of damage through interaction with the processor 320. The damage calculator 230 may deliver the first information on the manpower and cost required for recovery of damage to the receiver 110 and an output unit (not shown) such as a display may output the first information.

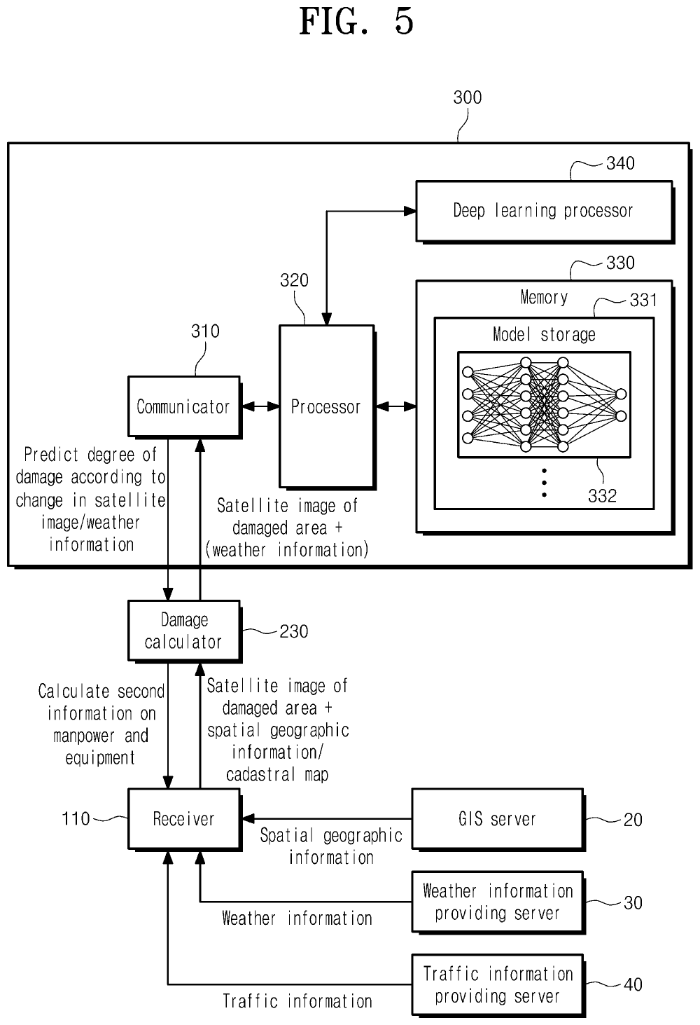

As described above, the disaster response system 1000 according to an example embodiment may calculate manpower and cost information for recovery of damage in the damaged area and may calculate information on the manpower and the equipment required for recovery of the damaged area in consideration of an amount of time used until the manpower and the equipment arrive. The detailed configuration of predicting a degree of damage in consideration of a change (a change rate, a degree of damage, and a spread degree of damage) in the satellite image based on AI is further described with reference to the accompanying drawings. Here, FIG. 5 is a diagram illustrating a detailed configuration for information exchange between an AI server interacting a disaster response system and a damage calculator and an external server according to an example embodiment.

Description related to a detailed operation of the detailed configuration of the AI server 300 of FIG. 5 refers to the description related to the detailed operation made with reference to FIG. 4. The processor 320 of FIG. 4 inputs satellite images over time in the damaged area and predicts a degree of damage according to a change in the satellite images. Meanwhile, the processor 320 of FIG. 5 inputs satellite images and additional auxiliary information over time in the damaged area and predicts a degree of damage according to the change in the satellite images and the additional auxiliary information.

The learning model 332 of FIG. 4 for predicting a degree of damage according to the change in the satellite image may be one single model. Meanwhile, the learning model 332 of FIG. 5 for predicting the degree of damage according to the change in the satellite image and the additional auxiliary information may include at least two learning models. For example, the learning model 332 in which a first learning model configured to predict a degree of damage according to the change in the satellite image and a second learning model configured to predict a degree of damage according to the change in the additional auxiliary information are combined may be used.

Referring to FIG. 5, the damage calculator 230 may calculate second information on manpower and cost required for recovery of damage using the real-time satellite image, spatial geographic information, auxiliary information on a cadastral map, and first information on manpower and cost. The damage calculator 230 may calculate second information on support manpower and equipment required for recovery of damage using a real-time satellite image, spatial geographic information, a cadastral map, auxiliary information on weather information, and first information. To this end, the damage calculator 230 may interact with the GIS server that provides spatial geographic information and auxiliary information on the cadastral map. Also, the damage calculator 230 may interact with the weather information providing server that provides auxiliary information on the weather information. Also, the damage calculator 230 may interact with the traffic information providing server 40 that provides real-time traffic information.

Accordingly, the damage calculator 230 may detect a change in the satellite image and a change in weather information in the damaged area through the deep learning module or the AI server 300 and may predict a degree of damage according to the change in the satellite image and the change in the weather information. The damage calculator 230 may calculate first information on the manpower and the cost required for recovery of damage in the damaged area based on the predicted degree of damage and may calculate second information on the support manpower and equipment required for recovery of the damage. Here, in the case of a disaster such as a forest fire, it is possible to accurately predict a degree of damage, a scale of damage and a scale of recovery of damage in the future by further applying weather information, such as a wind direction, a wind speed, a temperature, and a humidity. As another example, in the case of extreme weather, such as earthquake, typhoon, or tsunami, it is possible to accurately predict a degree of damage, a scale of damage, and a scale of recovery of damage in the future by further applying additional weather information related to earthquake, typhoon, or tsunamic from a current point in time to a certain period of time.

Meanwhile, the damage calculator 230 may detect a change in traffic information from a first place to which the support manpower and equipment are to be dispatched to a second place in the damaged area through the deep learning module or the AI server 300. The damage calculator 230 may predict a spread degree of damage according to an arrival time of the support manpower and equipment based on the change in the satellite image, a change in the weather information, and the change in the traffic information. The damage calculator 230 may calculate an additional input of the support manpower and equipment based on the predicted spread degree of damage. Therefore, if the predicted spread degree of damage is predicted to spread to a third place adjacent to the second place, the damage calculator 230 may control a portion of the additional input of the support manpower and equipment to be dispatched to the third place.

Therefore, the damage calculator 230 of the disaster response system 1000 according to the present invention may more accurately predict a scale of damage and a spread degree of damage in the future using AI and may add and distribute the manpower and equipment required for recovery in consideration of the spread degree of damage/damaged area. Also, the damage calculator 230 may predict an arrival time of manpower and equipment required for recovery according to real-time traffic information and, if the degree of damage exceeds a threshold according to a delay of the arrival time, may perform a traffic control of a corresponding path. Therefore, the damage calculator 230 may decrease the arrival time of manpower and equipment required for recovery in the damaged area and may minimize the spread of damage.

A disaster response system using a satellite image according to example embodiments is described above. The technical effect of the disaster response system using the satellite image according to the example embodiments may be as follows.

According to example embodiments, it is possible to provide a system capable of coping with monitoring, warning, and damage scale estimation related to disasters through a single process using a satellite image.

According to example embodiments, it is possible to predict a damage occurrence probability, to determine a damage occurrence status, and to predict a scale of damage according thereto based on a satellite image, spatial geographic information, and weather information.

According to example embodiments, it is possible to predict a simple damage occurrence status and to accurately predict a type of damage and a scale of damage predicted for each specified zone.

According to example embodiments, it is possible to more accurately predict not only a current degree of damage but also a scale of damage and a spread degree of damage in the future through deep learning AI and to add and distribute manpower and equipment required for recovery in consideration of the spread degree of damage/damaged area.

The additional scope of applicability of the present invention may become apparent from the following detailed description. However, it will be clearly understood by one of ordinary skill in the art that various modifications and changes may be made without departing from the spirit and scope of the present invention. Therefore, it should be understood that the detailed description and specific example embodiments such as example embodiments of the disclosure are given as examples only.

The features and effect of the present invention will become apparent through the following detailed description by referring to the accompanying drawings. Therefore, the technical spirit of the present invention may be easily implemented by one of ordinary skill in the art to which the present invention pertains.

Since various changes may be made and example embodiments may be provided to the present invention, specific example embodiments are illustrated in the drawings and described in detail in the detailed description. However, it does not intend to limit the present invention to specific implementations and it should be understood to include all modifications, equivalents, and replacements without departing from the spirit and scope of the present invention.

According to software implementation, not only the procedures and functions described herein but also design and parameter optimizations related to each of components may be implemented as a separate software module. A software code may be implemented as a software application written in an appropriate program language. The software code may be stored in a memory and may be executed by a controller or a processor.

What is claimed is:

1. A disaster response system using a satellite image, the disaster response system comprising:
a receiver configured to receive a captured image from a satellite;
a storage configured to operatively couple to the receiver and to store the received satellite image; and
a central processing device configured to operatively couple to the receiver and the storage and to predict a damage occurrence probability according to occurrence of a disaster through a time series change in the satellite image, to determine a damage occurrence status, and to calculate a scale of damage in response to occurrence of the damage.

2. The disaster response system of claim 1, wherein the central processing device comprises:
a monitoring unit configured to predict a type of disaster and the damage occurrence probability in a satellite image shooting area through connection to a geographic information system (GIS) server configured to provide spatial geographic information and a weather information providing server configured to provide weather information;
a determination unit configured to detect a time series change rate of the received satellite image and to determine occurrence of damage according to the disaster; and
a damage calculator configured to calculate the scale of damage according to the occurrence of the disaster.

3. The disaster response system of claim 2, wherein the monitoring unit comprises:
a zone detection module configured to specify the satellite image shooting area based on the weather information;
a first prediction module configured to predict a type of damage predicted for each zone of the specified satellite image shooting area; and
a second prediction module configured to predict the damage occurrence probability and a scale of damage based on the weather information and the type of damage predicted for each zone.

4. The disaster response system of claim 2, wherein the determination unit comprises:
a damage occurrence determination module configured to determine the damage occurrence status and a type of damage that has occurred through the satellite image; and
a control module configured to specify a damaged area and to request a high-resolution satellite image of the damaged area.

5. The disaster response system of claim 2, wherein the damage calculator comprises:
a damage scale calculation module configured to distinguishably predict human damage using a damaged area and nearby terminal location information and physical damage using spatial geographic information; and
a support scale estimation module configured to estimate a scale of support for recovery of damage according to the scale of damage, and
the damage calculator is configured to,
detect a change in the satellite image of the damaged area through a deep learning module or an artificial intelligence (AI) server and to predict a degree of damage caused by the change in the satellite image, and
calculate first information on manpower and cost required for recovery of damage in the damaged area based on the predicted degree of damage.

6. The disaster response system of claim 5, wherein the damage calculator comprises:
a database configured to periodically receive, update, and manage information on a location and a scale of support manpower and equipment; and
a support resource selection module configured to select support manpower and equipment using a real-time satellite image according to the scale of support estimated by the support scale estimation module, and
the damage calculator is configured to calculate second information on the support manpower and equipment required for recovery of the damage using the real-time satellite image, spatial geographic information, a cadastral map, auxiliary information on the weather information, and the first information on the manpower and the cost.

7. The disaster response system of claim 6, wherein the damage calculator is configured to:
detect the change in the satellite image of the damaged area and a change in the weather information through the deep learning module or the AI server and predict a degree of damage according to the change in the satellite image and the change in the weather information, and
calculate the first information on the manpower and the cost required for recovery of the damage in the damaged area and the second information on the support manpower and equipment required for recovery of the damage based on the predicted degree of damage.

8. The disaster response system of claim 6, wherein the damage calculator is configured to,
detect a change in traffic information from a first place to which the support manpower and equipment are to be dispatched to a second place in the damaged area through the deep learning module or the AI server,
predict a spread degree of damage according to an arrival time of the support manpower and equipment based on the change in the satellite image, a change in the weather information, and the change in the traffic information,
calculate an additional input of the support manpower and equipment based on the predicted spread degree of damage, and
control a portion of the additional input of the support manpower and equipment to be dispatched to a third place when the predicted spread degree of damage is predicted to be spread to the third place adjacent to the second place.
